(19) United States
(12) Patent Application Publication
(10) Pub. No.: US 2010/0175457 A1
(43) Pub. Date: Jul. 15, 2010

(54) APPARATUS AND METHOD FOR ANALYTIC ANALYSIS UTILIZING METHANOL RINSING

(76) Inventors: Edward K. PRICE, Liberty Township, OH (US); Eric T. Heggs, Camden, OH (US)

Correspondence Address: MCGUIREWOODS, LLP, 1750 TYSONS BLVD, SUITE 1800, MCLEAN, VA, 22102, US

(21) Appl. No.: 12/353,775

(22) Filed: Jan. 14, 2009

(51) Int. Cl. G01N 30/06

(52) U.S. Cl. 73/23.41

(57) ABSTRACT

An analysis system and method including a combined purge and trap (P&T) concentrator and P&T autosampler (generally, together, “the P&T system”) in conjunction with a gas chromatograph may be under control of a microprocessor that may control the various valve operations, syringe operations, cleaning operations, sample acquisition, and the like. The system includes automatic controls to clean the various components of the system such as valves and pathways, etc., using methanol, perhaps combined other cleaning techniques, between samples so that any residual contaminates remaining in a part of the system from one sample are minimized from affecting the results of an analysis of a subsequent sample. The automated methanol rinse greatly improves accuracy of sample analysis from one sample to the next.

### BACKGROUND OF THE INVENTION

1.0 Field of the Invention

The invention is directed generally to an apparatus and method for analytic analysis of sample material and, more particularly, to an apparatus and method for analytic analysis of sample material that includes methanol rinsing features.

2.0 Related Art

While gas chromatography (GC) may be a very powerful analytical tool for analyzing chemical composition of sample material, it does have several limitations. The Purge & Trap technique (P&T) has been developed to overcome some of the limitations. The P&T technique may be used for analysis of a wide variety of liquid & solid samples such as drinking water, wastewater, high & low-level soils, or the like. The limitations, which P&T concentration has been designed to overcome, include for example:

Lack of Sensitivity.
GC detectors provide remarkable sensitivity. However, there are a number of areas where even greater sensitivity may be necessary. These areas might include:
   a) Environmental Analysis—many pollutants typically must be measured at low levels; sometimes, in the sub-part-per-billion (ppb) range.
   b) Flavor and Fragrance Analysis—the human nose is one of the most sensitive detectors in existence. To provide an analytical system with comparable sensitivity, some method of concentration is required.

Inability to Tolerate Water Injections.
Many GC columns and detectors do not perform well in the presence of water. Water may drastically reduce the lifetime of the column and adversely affect the detector performance.

The Sample Must be in Vapor or Vaporizable Form.
GC operates as an interaction between vapor and liquid phases. Usually, the sample must start out as a vapor. For this reason, there are many samples, such as pollutants in soil, or flavors in solid food, which cannot be directly introduced into a GC. The ability to analyze volatile organic compounds (VOCs) is often an important part of environmental monitoring, out gassing studies, flavor or fragrance analysis, among others. P&T is a technique that separates the VOCs from a matrix. After separation, the VOCs may be concentrated and injected into the GC for separation.

Purge and Trap Operation Overview

A measured amount of sample may be placed in a sealed vessel. The sample may be purged with inert gas, causing VOCs to be swept out of the sample. The VOCs may be retained in an analytical trap, which allows the purge gas to pass through to vent. The VOCs may be then desorbed by heating the trap, injected into the GC by backflushing the trap with carrier gas, and separated and detected by normal GC operation. The system is then regenerated to allow for sequential samples to be completed.

Purging

In the paragraph above it states, “The sample may be purged with an inert gas, causing VOCs to be swept out of the sample.” This is a very simple-sounding way of describing what may be in reality a rather complex process. Purging a sample to extract analytes is a gas extraction. There are many factors that affect the efficiency of this extraction. The amount of each compound purged is proportional to both its vapor pressure and its solubility in the sample. Both of these may be, in turn, affected by the sample temperature.

Consider the exemplary case of a sample sealed in a closed vial, as depicted by FIG. 1A. Above the sample is a vapor space, which is usually referred to as the headspace. If one allows the sample sufficient time, VOCs in the sample migrate into the vapor space, as depicted generally by FIG. 1B. After a certain period of time, equilibrium will be established; and the concentration of the volatile compounds in each phase will be stabilized.

At this point a portion of the headspace can be removed and injected into the GC for analysis. The technique is known generally as Equilibrium Analysis or Static Headspace Analysis. The amount of material in the vapor phase will be proportional to the partial pressure of the component.

In purging a sample, the system is no longer at equilibrium. This is because the VOCs that move into the vapor phase are constantly being removed by the purge gas. Under these circumstances, there is no migration of components from the vapor to liquid phase. This means that the partial pressure of any individual component above the sample at any time is essentially zero. This encourages even greater migration of the VOCs into the vapor phase, purging the sample more efficiently. Purging a sample for 10 minutes with helium or other inert gas (at a flow rate of 50 ml/min.) results in a more efficient extraction of volatiles than equilibrium, using 500 ml headspace, for example. This purging technique is called Dynamic Headspace Analysis. For aqueous matrices, the increase in efficiency can be upwards of 100 fold, using dynamic versus static headspace analysis.

Extraction efficiency increases with an increase in sweep volume. Sweep volume, a function of sweep time and flow rate, is the amount of purge gas used to extract the analytes. Since the analytes may be trapped on a sorbent bed, there are limitations to the sweep times and flow rates that can be used. These limitations are determined by the compounds of interest in the sample and the sorbent material used in the trap.

Trapping and Adsorption

An analytical trap may be a short gas chromatograph column. Compounds entering the trap may slowly elute with a measurable retention volume. Retention volume is the amount of purge gas that passes through the trap before elution of the analytes begins to occur. Generally, the requirements of a trap may include the following:
At low temperatures, it must retain the analytes while allowing oxygen and water to pass through unimpeded.
Upon heating, it must release the analytes quickly and efficiently.
When heated, it must show stability and not contribute to volatiles.
It must operate without causing any catalytic reactions.
It should have a reasonable price and lifetime.

At lower trap temperatures, retention volumes may be high. At higher desorption temperatures, retention volumes may be much smaller, allowing rapid transfer to the GC. In this context, the use of retention time is typically incorrect. The correct parameter is typically retention volume.

When elution does occur, it is usually referred to as breakthrough, and the retention volume, at which breakthrough occurs, is often referred to as the breakthrough volume. Sorbent materials are usually chosen so that the breakthrough volume is high for analytes and low for water. Care must be taken that the sorbent chosen does not retain the analytes too strongly or efficient desorption may not be possible. Traps containing combinations of sorbents are often used to enhance performance.

The trap may be packed with the weaker sorbent on top. The stronger sorbent may be placed below the weaker sorbent. Less volatile analytes that are not effectively desorbed by the stronger sorbent may be retained by the weaker sorbent. Therefore, the less volatile analytes fail to reach the stronger sorbent. Only the more volatile analytes reach the stronger sorbent; and because of their volatility, these analytes can be efficiently desorbed. The desorption may be carried out by back flushing the trap, ensuring that the heavier analytes never come in contact with the stronger sorbent.

However, the exemplary processes described above have limitations in that the backflushing and cleaning procedures generally may not be sufficient to adequately cleanse the system components between samples, giving rise to inaccurate results because of contaminants remaining in system between samples.

### SUMMARY OF THE INVENTION

The invention meets the foregoing need and provides a method and system for backflushing and cleaning system components between samples.

In one aspect, a method for cleansing an analysis system is provided that includes sampling a sample for analysis in a analysis system, cleaning at least a portion of the analysis system with methanol, rinsing at least a portion of the analysis system with a second cleaning agent, wherein the cleaning step and rinsing step are performed automatically to reduce a residual contaminate from influencing a subsequent analysis.

In another aspect, a method for minimizing a potential of cross contamination or memory effect between sample analyses is provided including sampling a first sample for analysis under automatic control in a combined purge and trap (P&T) concentrator and P&T autosampler having interconnecting passageways and flushing at least a portion the interconnecting passageways with methanol, the flushing under automatic control, wherein the flushing is preformed automatically without manual intervention to minimize a risk of contaminants from the first sample to affect an analysis of a second sample.

In another aspect, a system for analyzing samples is provided that includes a combined purge and trap (P&T) concentrator and P&T autosampler for preparing samples for analysis, a methanol source and a controller for automatically controlling a cleaning operation to clean at least a portion of the combined P&T concentrator and P&T autosampler with methanol from the methanol source to minimize residual contaminants from a first sample from affecting analysis results of a subsequent second sample.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIGS. 1A and 1B are illustrations of an exemplary sample sealed in a closed vial, with FIG. 1B, showing a principle of volatile organic compound migration into vapor space;

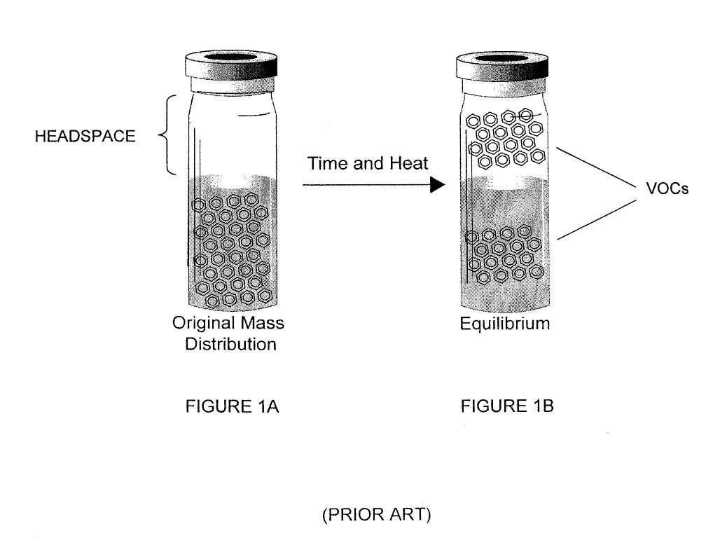

FIG. 2 is a schematic of an exemplary combined purge and trap (P&T) concentrator and P&T autosampler, configured according to principles of the invention;

FIG. 3 is a block diagram of an analysis system that includes the combined purge and trap (P&T) concentrator and P&T autosampler of FIG. 2, a gas chromatograph, detector and a controller, configured according to principles of the invention;

FIG. 4 is a flow diagram of a process of an embodiment, the steps of the process performed according to principles of the invention; and

FIG. 5 is a flow diagram of a process of an embodiment, the steps of process performed according to principles of the invention.

### DETAILED DESCRIPTION OF THE INVENTION

It is understood that the invention is not limited to the particular methodology, protocols, etc., described herein, as these may vary as the skilled artisan may recognize. It is also to be understood that the terminology used herein is used for the purpose of describing particular embodiments only, and is not intended to limit the scope of the invention. It is also to be noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

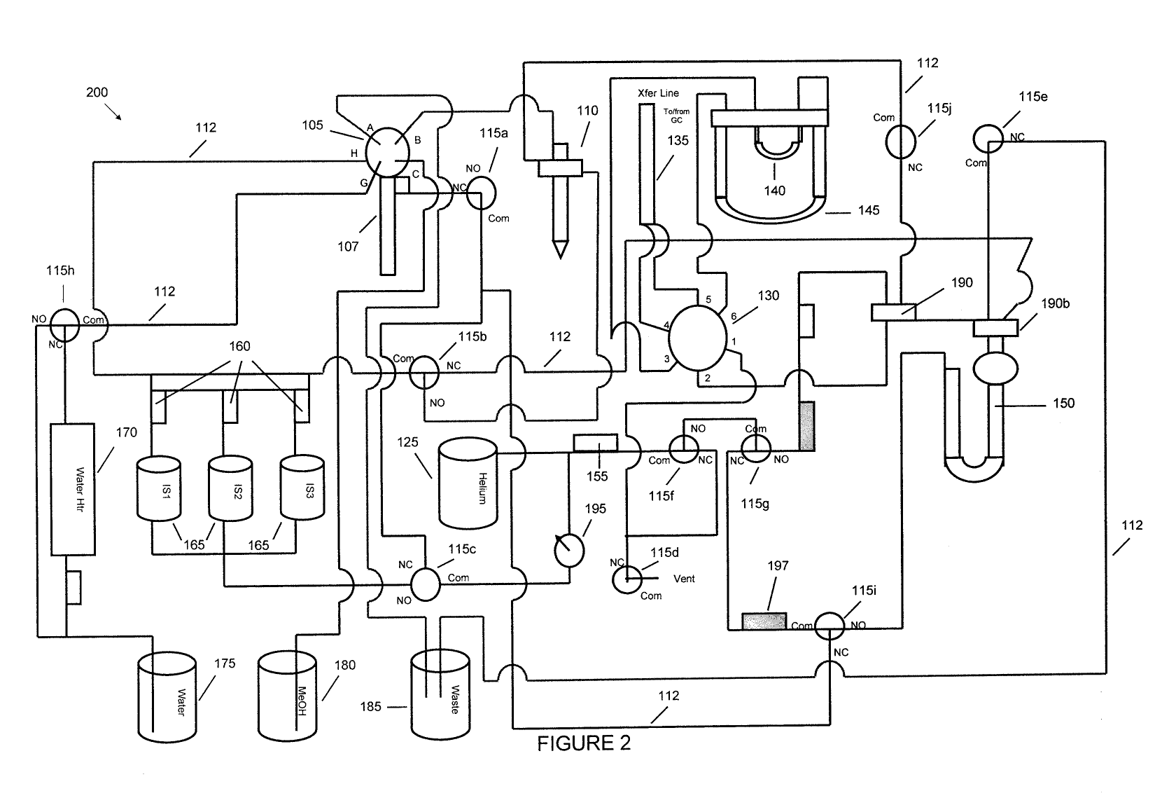

FIG. 2 is a schematic of an exemplary combined purge and trap (P&T) concentrator and P&T autosampler (generally, together, “the P&T system”), configured according to principles of the invention, and generally denoted by reference numeral 200. The control and operation of the P&T system may be under control of a computer (not shown) that may control the various valves (e.g., valves 115a-j), syringe operations, cleaning and sample acquisition, and the like, which may be connected by pathways 112 (only a few pathways are denoted by reference numeral 112 to reduce the overall amount of reference numerals in FIG. 2, but other pathways are included as shown). The pathways 112 may be glassware, stainless steel, Teflon®, PEEK, or the like. The pathways 112 may be acquired from various manufacturers such as Upchurch Scientific (e.g., PEEK tubing) or Restek (e.g., Siltek tubing).

The P&T system 200 may generally include a plurality of valves such as rotary selection valves 105, 130 to aid in controlling operational acquisition, processing and testing of sample materials. The P&T system 200 may also include syringe drive assembly 107 for acquiring and inserting solutions including solvents, water, methanol and standard references, for example, into the pathways 112 of the P&T system 200. For example, the syringe assembly 107 may acquire methanol from a methanol source 180, an unheated water source 175, and/or dispose of wastes such as waste liquids, excess sample, cleaning liquids in a waste reservoir 185, all as part of the P&T system 200. Alternatively, hot water may be acquired from a provided heated water reservoir 170, perhaps chosen in lieu of the unheated water source 175 by a valve 115h for certain cleansing operations of the P&T system 200. The heated water reservoir 170 may be configured to be tapped for rinsing, perhaps by selective activation of a valve 115h.

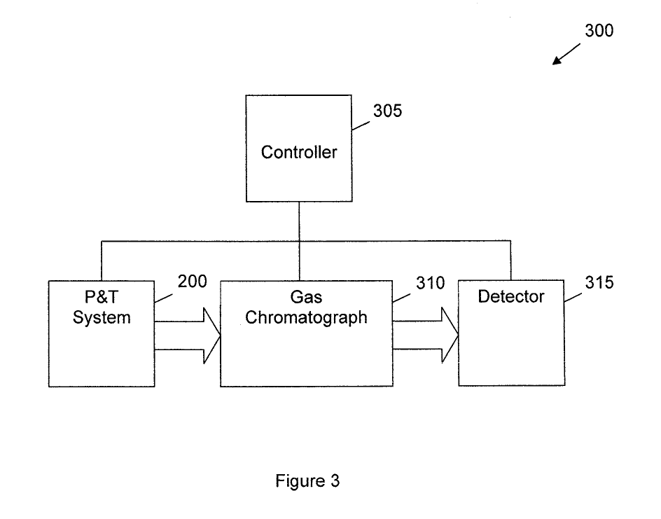

The P&T system 200 may further include a three stage needle 110 configured to acquire a sample from a vial of sample material. The needle 110 may be interconnected with the syringe assembly 107, sample transfer valve 115b and the soil valve 115j. The analytical trap 145 may be a carbon trap for trapping volatile organic compounds (VOCs). A second rotary selection valve 130 may be configured to connect pathways 6-1, 2-3, 4-5 in a first position, and to connect pathways 1-2, 3-4, 5-6 in a second position. The second rotary selection valve 130 may connect either the sample glassware 150, in the case of liquid samples or the sample needle in the case of solid samples to the condensing trap 140 and the analytical trap 145 to allow for concentration of the sample. The analytical trap 145 may be a carbon trap for trapping volatile organic compounds (VOCs). The rotary valve 130 may be employed to provided connectivity as needed to a heated transfer line assembly 135 to heat the solution to about 250° C., for example. The transfer line assembly 135 may contain two discrete lines, one that routes the carrier gas of a connected gas chromatograph (GC) 310 (FIG. 3) to port #4 on the 6-port rotary valve 130, and the other line returns the carrier gas to the GC 310 at port number #5. In the standard 6-port valve positions 4 and 5 are connected together. When the valve is actuated carrier gas flows through the heated analytical trap 145 prior to returning to the GC 310. Certain sections of the pathways 112 may be selectively pressurized at about 50-100 psi, as required. A mass flow controller 155 may be employed along with a pressure regulator 195 to maintain acceptable levels of pressure in other sections of pathways 112, perhaps at 7 psi, for example.

Clean gas passing along the pathway, may be selectively controlled by valves 115g, 115f. The purge select valve 115i may be configured to pass an inert gas, such as helium from a helium source 125, through liquid or solid/liquid mixure to extract volatile organic material. In the case of liquid samples, the inert gas will be routed to the sample glassware 150; in the case of solid samples, the inert gas will be routed to the three stage sample needle 110. The sample glassware 150 may be interconnected with one or more cross-couplers 190a, 190b as appropriate to the rotary selection valve 130. The sample needle may be connected to the rotary valve 130 via one or more cross-couplers 190 and the soil valve 115j. One or more internal standards 165 may be employed for insertion, as needed, into a sample as a known reference, perhaps by way of an internal dosing valve 160.

FIG. 3 is a block diagram of an analysis system that includes the combined purge and trap (P&T) concentrator and P&T autosampler of FIG. 2, a gas chromatograph and a controller, configured according to principles of the invention, generally denoted as reference numeral 300. The P&T system 200 may be interfaced with a transfer assembly 135 to a GC 310 for analysis of the prepared sample delivered by the transfer line assembly 135. A detector 315 may detect the individual components of the sample. Controller 305 may be any suitable computing platform such as a personal computer, for example, and may be interconnected to the P&T system 200, the GC 310 and the detector 315 for overall automatic control of the process, and perhaps initiating storing of data based on results of the detector 315 output. The controller 305 may interface with a database (not shown) to store any results, and/or process/sample history. The controller 305 may communicate the sample schedules and methods to the microprocessors of the P&T system 200 which may control the overall processes herein, including but not limited to controlling one or more of: the sequencing of any valve(s) including rotary selection valves 105, 130, the operation of the syringe drive assembly 107, needle 110, temperature settings, regulators, internal standard reference acquisition (e.g., one or more internal standards 165), regeneration, waste recovery, pressure settings, purging, cleaning, sample acquisition and release, and the like. The controller 305 may also control the operation of the GC 310, and the detector 315 for acquiring results of the analysis and to record detected components of the sample(s). The controller 305 may schedule analysis of multiple samples without manual intervention once the process has been initiated, and without replacement of any P&T system part, described more fully below.

System Regeneration

The P&T system 200 may provide for multiple samples to be completed without the need to run blanks or replace parts between analyses. To accommodate this, the sample pathways including lines, tubing, valving, glassware and analytical trap(s) may be regenerated automatically between samples, without a need to decrease throughput by inserting blanks between samples to eliminate potential cross contamination. The P&T system 200 parts may be cleaned via methanol flush, water and flushing with an inert gas, this technique is very effective to minimize the potential of cross contamination or memory effect between sample analyses during normal operation.

Automation

Since the P&T system 200 is configured to complete multiple analyses without manual intervention, automation provides increases productivity of the system overall and for the operator. A single P&T system 200 can provide the user with automation of liquid, solids and high level samples. Each of these sample types require different sample handling needs.

Liquid Samples

Traditionally, liquid samples are typically received in 40 ml VOA vials, but other sizes are contemplated. The vials may be filled to the top and sealed with no headspace in the vial thus not allowing any VOCs to partition into the gas phase.

A user of the P&T system 200 may schedule the system to complete a water sample at a particular position within the system, the user may then load the vial into the scheduled position. Once the P&T system 200 is started the vial may be pierced with a needle 110 where the liquid sample can be positively displaced to a measuring device such as a fixed loop or variable volume syringe drive assembly 107. A user specified volume of liquid may be displaced from the vial, may be spiked 160 with standards 165 as it is delivered to the sample glassware 150 for purging as described above. In the case of high-level liquid samples a very small volume of the highly concentrated liquid may be removed from the vial and mixed with deionized (DI) water 175 to effectively dilute the sample for analysis.

After the sample has been removed from the vial, the spent vial may be returned to the autosampler and the liquid sample pathway such as valves, tubing, glassware, sparge vessel, sampling needles, valves, syringes and manifolds may be cleaned via methanol rinsing, water rinsing, and also inert glass flushing.

Low-Level Solids

A low-level solid sample is typically weighed into a 40 ml VOA vial containing a magnetic stir bar. The user may schedule the system to complete the solid sample at a particular position within the system, the user may load the vial into the scheduled position. Once the schedule is started, the autosampler may pierce the vial with the three stage sample needle 110, DI water 175 may be added to the vial that has been spiked 160 with a known standard 165. The soil may be stirred via the magnetic stir bar and it may be purged directly in the vial. Upon completion of the solid sample the spent vial may be return to the autosampler and the sample pathway including valves, tubing, needle and manifolds are typically cleaned via methanol rinsing, water rinsing and inert glass flushing.

High-Level Solids

A high-level solid sample is typically weighed into a 40 ml VOA vial containing a magnetic stir bar. The user may schedule the system to complete the solid sample at a particular position within the system, and the user may then load the vial into the scheduled position. Once the schedule is started the system may pierce the vial with the three stage sample needle 110, then methanol 180 may be added to the vial that has been spiked 160 with a known standard 165. The soil may be stirred via the magnetic stir bar, and after an allotted mix time, the soil may be allowed to settle to the bottom of the vial. After settling has occurred, a very small volume of the highly concentrated methanol extract may be removed from the vial via a syringe drive 107 and mixed with DI water 175 to effectively dilute the sample. The diluted sample may be delivered to the sample glassware 150 for purging as described above.

After the sample has been removed from the vial the spent vial may be returned to the autosampler and the liquid sample pathway including valves, tubing, glassware and manifolds may be cleaned via methanol rinsing, water rinsing and inert glass flushing.

The P&T system 200 combines a P&T concentrator and a P&T autosampler into one system thus allowing for the elimination of redundant parts and complexity. The P&T system 200 provides for automation of high-level solid samples via automation of the technique described above.

Currently, prior to the invention, users complete “blank” samples after high-level samples have been scheduled to insure that the previous sample does not influence the next sample. This problem is especially prevalent when high-level water samples are automatically diluted by an autosampler system. To complete an automatic dilution of the sample, the raw sample may be displaced to the syringe 107 and a small volume sample followed by DI water 175 may then be dispense to the sample glassware 150. When using this dilution technique the high level sample is in direct contact with several common pathways in the system that could create a memory effect in the system. It should be noted that when doing dilutions, the raw sample could be 100 times higher, for example, than the operating range of the system. For example, if the system is calibrated from 1 ppb to 200 ppb a raw sample could be in dilution 1:100, thus making the raw sample a concentration of 20,000 ppb or 20 ppm. In this situation even a 0.1% carryover/memory of the raw sample would result in an erroneous 20 ppb contribution to the following sample.

This carryover/memory situation might also be present when automating high-level soil analysis or if a high level sample is analyzed, perhaps without a dilution performed prior to analysis. If this situation is not addressed efficiently it may result in inaccurate results due to contribution of previous samples. The addition of blank samples in subsequent analyses is often necessary to prove system cleanliness before continuing to the next sample analysis. This results in a decrease of the overall throughput of the system. Potential manual intervention to clean and restore the system to a functional level is also not desirable. Current P&T auto samplers try to mitigate this carryover by using a hot or cold water rinse which has reduced carryover somewhat. However, as provided by the invention, a combination of a methanol rinse followed by a water rinse has resulted in a 2-10 fold decrease in sample carryover. This minimizes a risk of contaminants from a first sample to affect an analysis of a second sample and reduces the need to run blank samples between sample analyses.

The invention includes providing for allowing a user to automatically rinse the common parts within the system including valves, tubing, glassware and manifolds with methanol to reduce carryover. This may be preprogrammed into a computerized controller for automatic operation. The automated methanol rinse may reduce carryover/memory effects experienced when handling a high level sample. The ability to completely clean the system between samples may allow for better data quality, increased unit throughput, since additional blank samples will not be required for example, and reduced manual maintenance due to liquid and vapor level contamination of the sample pathways.

To accomplish this, a methanol source 180 may be connected to the syringe drive assembly 107 via a multi-port fluid selection valve 105. This may allow for a precise volume of methanol to be drawn into the syringe drive assembly 107 and then pushed through common liquid handling components such as: syringe, valves, needles, tubing, manifolds, glassware, or the like. Since methanol is an excellent solvent for volatile compounds of interest in P&T/GC analysis, the methanol functions as a much more productive cleaning agent when compared with water or inert gas. The methanol rinse may be followed by a water rinse, and may be followed by an inert gas flush to complete the cleaning procedure. Early results have indicated a 2-10 fold reduction in carryover versus the use of a water rinse and followed by an inert gas flush.

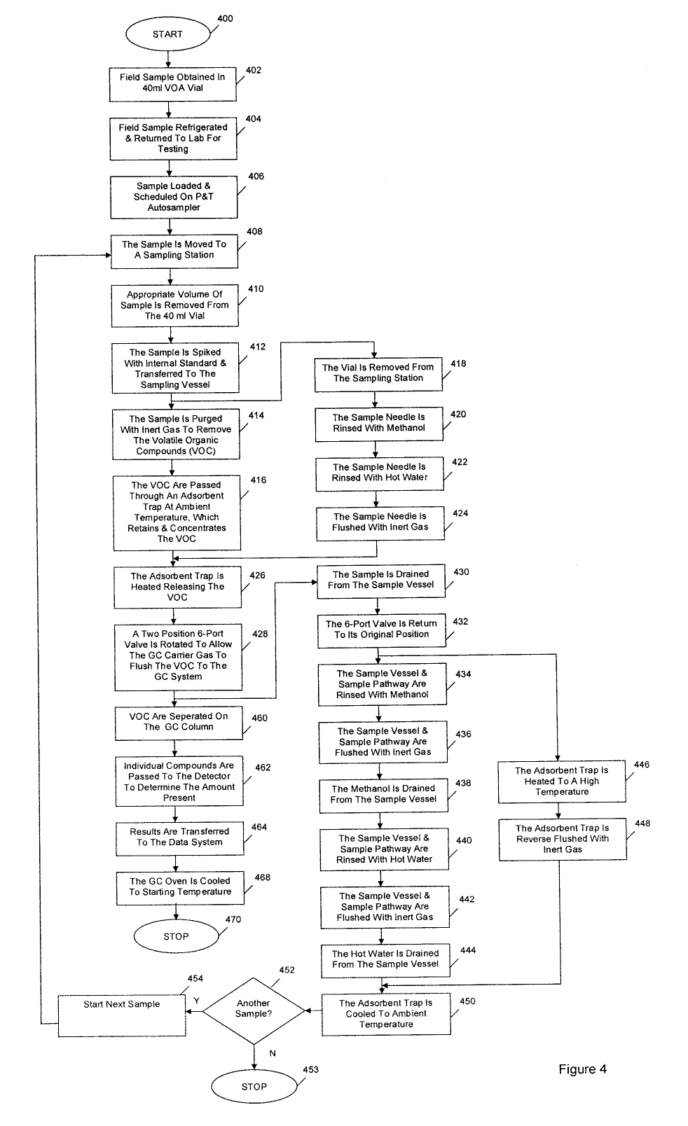

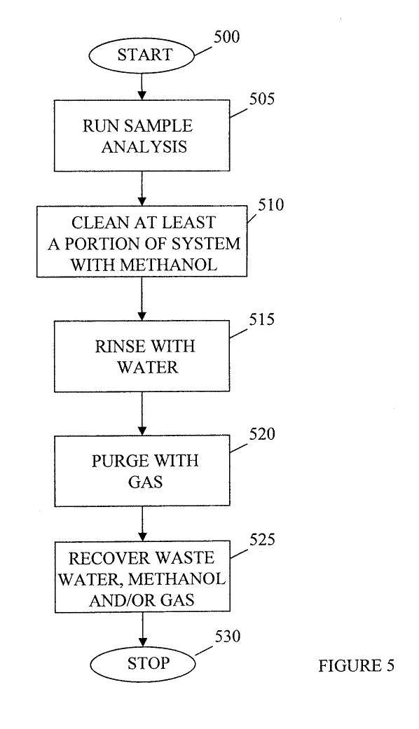

FIG. 4 is a flow diagram of process showing steps of an embodiment for performing a regeneration of an analysis system when completing water samples, the steps performed according to principles of the invention, starting at step 400. The flow diagram of FIGS. 4 and 5 may also represent a block diagram of components to perform the respective steps thereof. At step 402, field samples may be obtained for analysis, typically in 40 ml volatile organic analysis (VOA) vials, but other size vials may be employed. At step 404, the sample may be refrigerated and returned to a lab for testing. At step 406, the sample may be loaded and scheduled on a P&T autosampler. At step 408, the sample may be moved to a sampling station.

At step 410, an appropriate volume of sample may be removed from the vial and transferred to the sample glassware 150. At step 412, the removed sample may be spiked with an internal standard (e.g., from internal standard vessels 165) and transferred to a sampling vessel 150.

At this point, parallel processes may proceed at step 418 and another at step 414. Continuing first with step 418, the vial may be removed from the sampling station. At step 420, the sample needle may be rinsed with methanol. At step 422, the sample needle may be rinsed with hot water. At step 424, the sample needle may be flushed with inert gas. The process may continue at step 426.

Continuing with the other parallel process, at step 414 the sample may be purged with inert gas to remove the volatile organic compounds (VOC). At step 416, the VOC may be passed through an absorbent trap (e.g., trap 145) at ambient temperatures, which may retain and concentrate the VOC.

At step 426, the absorbent trap may be heated to release the VOC. At step 428, a two-position 6-port valve (e.g., rotary valve 130), or equivalent, may be rotated to allow the GC carrier gas to flush the VOC to the GC.

A pair of parallel processes may proceed at this point. The first parallel process may begin at step 460 where the VOC may be separated on the GC (e.g., GC 310). At step 462, individual components may be passed to the detector (e.g., detector 315) to determine amounts present. At step 464, results may be transferred to a data system and/or database for subsequent use and/or reporting of findings. At step 468, the GC oven may be cooled to a starting temperature. At step 470, this parallel process may stop or suspend until another sample is processed.

A second parallel process may proceed following step 428 with step 430 where the sample may be drained from the sample vessel. At step 432, the 6-port rotary valve (e.g., 130) may be returned to its orignal position. Another set of parallel processing may now be performed, one beginning at step 434, and the other at step 446. At step 446, the absorbent trap may be heated to a high baking temperature, typically 10-20% hotter than the temperature used to transfer the VOC to the GC. At step 448, the absorbent trap may be reversed flushed with inert gas, while maintaining the hot bake temperature. The process may continue at step 450, described below.

Continuing with the other parallel process at step 434, the sample vessel and sample pathway may be rinsed with methanol. At step 436, the sample vessel and sample pathway may be flushed with inert gas. At step 438, the methanol may be drained from the sample vessel. At step 440, the sample vessel and sample pathway may be rinsed with hot water. At step 442, the sample vessel and sample pathway may be flushed with inert gas. At step 444, the hot water may be drained from the sample vessel.

At step 450, the absorbent trap may be cooled to ambient temperature. At step 452, a determination may be made as to whether or not another sample should be processed. If yes, the process may continue at step 454 where a next sample may be started. The process may continue at step 408. However, if there is not another sample, the process may stop at step 453.

FIG. 5 is a flow diagram of a process of an embodiment, the steps performed according to principles of the invention, starting at step 500. At step 505, a sample may be prepared and analyzed using an automated combined purge and trap (P&T) concentrator and P&T autosampler, and GC system (e.g., the systems of FIGS. 2 and 3). At step 510, at least a portion of the P&T system (e.g., P&T system 200) may be automatically rinsed with methanol. At step 515, at least a portion of the P&T system (e.g., P&T system 200) may be automatically rinsed with water, which may be hot water. At step 520, at least a portion of the P&T system may be purged with gas, which may be an inert gas. At step 525, the waste water, methanol and/or gas may be recovered for disposal or recycling. At step 530, the process may end.

As an example, the combined P&T system configured according to principles of the invention may also provide an ability to complete high-level soil samples via in-vial automatic methanol extraction. When using this technique, methanol may be added to a soil sample, which may be subsequently mixed and allowed to settle. After settling, an aliquot of methanol may be removed from the vial so it might be diluted by a pre-determined factor, such as 1:100, for example, and analyzed. An ability of the system configured according to principles described herein may include improved handling of an instance whereby a next sample to complete by the system could be a water sample which might require a detection level of about 0.5 ppb, for example, i.e., about 20,000 times lower than the liquid extraction processed prior to the water sample. So, in this example, the second analysis requires a detection level of more precision than a required detection level of the first sample. The various advantages of the methanol cleaning technique provided by the invention may provide for a better, more efficient cleaning of the system between these exemplary samples having disparate detection requirements, so that contaminants may be better removed between the two analyses to minimize and/or avoid erroneous results in the second analysis.

The invention also contemplates using other agents other than methanol including other alcohols, for example, as appropriate for an application.

While the disclosure has been described in terms of exemplary embodiments, those skilled in the art will recognize that the disclosure can be practiced with modifications in the spirit and scope of the disclosure. These examples given above are merely illustrative and are not meant to be an exhaustive list of all possible designs, embodiments, applications or modifications of the disclosure.

We claim:

1. A method for cleansing an analysis system, the method comprising:
sampling a sample for analysis in a analysis system;
cleaning at least a portion of the analysis system with methanol;
rinsing the at least a portion of the analysis system with a second cleaning agent,
wherein the cleaning step and rinsing step are performed automatically to reduce a residual contaminate from influencing a subsequent analysis.

2. The method of claim 1, wherein the step of rinsing includes rinsing with water.

3. The method of claim 1, further comprising the step of purging with a gas.

4. The method of claim 3, wherein the step of purging includes purging with an inert gas.

5. The method of claim 1, wherein the analysis system includes a combined purge and trap concentrator and a P&T autosampler.

6. The method of claim 1, further comprising analyzing the sample in a gas chromatograph.

7. The method of claim 1, wherein the steps for sampling, cleaning and rinsing are controlled automatically by a microprocessor.

8. The method of claim 1, further comprising recovering at least one of: waste methanol, waste water and waste gas.

9. The method of claim 1, wherein the step of rinsing the at least a portion of the analysis system includes rinsing at least one of: glassware, a pathway, a manifold, a sparge vessel, a syringe, a sampling needle, a tube and a valve.

10. The method of claim 1, wherein:
the step of sampling includes sampling a combined soil and methanol solution to provide the sample, and diluting the sample by a pre-determined factor for a first analysis; and
the steps of cleaning and rinsing removes contaminants from at least part of the analysis system to prevent contamination of a subsequent analysis requiring a detection level of more precision than the first analysis.

11. A method for minimizing a potential of cross contamination or memory effect between sample analyses, the method comprising the steps of:
sampling a first sample for analysis under automatic control in a combined purge and trap (P&T) concentrator and P&T autosampler having interconnecting passageways; and
flushing at least a portion of the interconnecting passageways with methanol, the flushing under automatic control,
wherein the flushing is preformed automatically without manual intervention to minimize a risk of contaminants from the first sample to affect an analysis of a second sample.

12. The method of claim 11, further comprising rinsing with water.

13. The method of claim 11, further comprising purging with an inert gas.

14. The method of claim 11, further comprising automatically operating one or more valves to initiate the sampling step and the flushing step.

15. A system for analyzing samples, comprising:
a combined purge and trap (P&T) concentrator and P&T autosampler for preparing samples for analysis;
a methanol source; and
a controller for automatically controlling a cleaning operation to clean at least a portion of the combined P&T concentrator and P&T autosampler with methanol from the methanol source to minimize residual contaminants from a first sample from affecting analysis results of a subsequent second sample.

16. The system of claim 15, further comprising a gas chromatograph to separate components of the first sample and the second sample.

17. The system of claim 15, further comprising a detector to detect at least one separated component.

18. The system of claim 15, wherein the controller initiates storing information related to the detected at least one component.

19. The system of claim 15, further comprising a water source for use in rinsing at least a portion of the combined P&T concentrator and P&T autosampler.

20. The system of claim 19, wherein the water source includes a heated water reservoir configured to be tapped for rinsing the at least a portion of the combined P&T concentrator and P&T autosampler.

21. The system of claim 20, wherein the water source is unheated and the water source and heated water reservoir are automatically selectable.
